(19) United States
(12) Patent Application Publication
(10) Pub. No.: US 2020/0072200 A1
(43) Pub. Date: Mar. 5, 2020

(54) HIGH-EFFICIENCY ION DISCHARGE METHOD AND APPARATUS

(71) Applicant: The Regents of the University of California, Oakland, CA (US)

(72) Inventors: Richard E. Wirz, Los Angeles, CA (US); Ben Dankongkakul, Panorama City, CA (US)

(73) Assignee: The Regents of the University of California, Oakland, CA (US)

(21) Appl. No.: 16/468,133

(22) PCT Filed: Dec. 14, 2017
(86) PCT No.: PCT/US2017/066388

§ 371 Date: Jun. 10, 2019

Related U.S. Application Data
(60) Provisional application No. 62/435,672, filed on Dec. 16, 2016.

(51) Int. Cl. F03H 1/00; H05H 1/11; H05H 1/46

(52) U.S. Cl. CPC F03H 1/0037; H05H 1/46; H05H 1/11

(57) ABSTRACT

An ion beam generator includes a discharge chamber with a backplate and tubular sidewalk A source of propellant, for example, Xenon gas is provided to the discharge chamber. First and second annular magnets are disposed on or near the backplate, and configured with alternating polarities such that a pair of ring-cusps form on the backplate, without any magnetic ring-cusp formation on the sidewalk A cathode assembly extends into the discharge chamber to provide primary electrons to ionize the propellant.

### CROSS-REFERENCE TO RELATED APPLICATION

This application claims the benefit of Provisional Application No. 62/435,672, filed Dec. 16, 2016, the entire disclosure of said application is hereby incorporated by reference herein.

### BACKGROUND

Modern DC ion thrusters have largely transitioned towards a ring-cusp confinement design. Kaufman discharges, which are used mainly for terrestrial ion sources, generally require higher discharge voltages (for example, ≥35 V) which lead to decreased performance and life. The high discharge voltage causes plasma generation inefficiencies and excessive erosion of the accelerator grid system and cathode source from internal ion sputtering. This leads to undesirable performance and mission lifetimes for both ion thrusters and terrestrial plasma sources. For plasma processing, the erosion increases maintenance intervals while the eroded material can contaminate and damage the substrate.

Ring-cusp ion beam generators commonly use rare-earth magnets, for example, samarium-cobalt magnets or neodymium-iron-boron magnets, to produce strong and relatively short-range magnetic fields that are well-suited for larger discharge chambers. The ring magnets are typically placed in alternative polarity on or near the sidewall of the discharge chamber. This arrangement generates strong magnetic cusps at the boundaries near the sidewalls confining the plasma, while the bulk plasma region experiences relatively low magnetic fields to achieve plasma uniformity near the discharge extraction plane, which is desirable for the performance and life of the device.

Therefore, the cusp magnetic fields are commonly treated as boundary-only effects. Design for a large field free extraction (e.g., ˜10 G) can easily be accomplished for larger devices (>10 cm in diameter). At small (<10 cm) and miniature scales (<5 cm), however, the cusp fields penetrate significantly into the discharge chamber and may have a strong effect on the uniformity and shape of the flow field region. Therefore, for smaller ion beam generators, multiple ring-cusps may produce complex and strong B-field structures that dominate most of the discharge chamber volume.

Traditional ring-cusp design principles have inherent design limitations for small and miniature scale devices because the reduced confinement volume results in both primary and plasma electrons loss to the same leak area(s). This is especially important at the miniature scale since the total cusp leak area must be adequate to extract a stable discharge current at a reasonable discharge voltages. However, this also creates a limitation for attaining sufficient primary electron confinement that is necessary for electron bombardment ionization.

A seminal disclosure of an ion beam discharge device in the form of a ring-cusp ion thruster is disclosed in U.S. Pat. No. 4,466,242, to Sovey et al., which is hereby incorporated by reference in its entirety. Sovey discloses an ion thruster having a discharge chamber 12 including a tubular wall or shell anode 14 with a flat backplate 16, also at anode potential. A hollow cathode assembly 20 extends through the backplate, and is configured to generate primary electrons that interact with the propellant gas to generate gas ions. A plurality of ring magnets polarized radially (i.e., generally perpendicular to the chamber axis) and oriented with opposed (alternating) polarity are fixed to the sidewall of the discharge chamber, producing ring-cusps at the anode wall. An accelerator grid system 18 at the outlet to the discharge chamber accelerates ions exiting the chamber to produce the ion beam, which in the Sovey apparatus (mentioned above) generates thrust.

An ion beam generator referred to as the Miniature Xenon Ion (MiXI) thruster (see, for example, Wirz, R., Sullivan, R. Przybylowski, J., and Silva, M., “Hollow Cathode and Low-Thrust Extraction Grid Analysis for a Miniature Ion Thruster,” International Journal of Plasma Science and Engineering, Vol. 2008, pp 1-11, which is hereby incorporated by reference in its entirety) is believed to represent the state of the art in high efficiency miniature ion source. The MiXI thruster uses a ring-cusp DC discharge and advanced ion optics to achieve a total efficiency of up to 56%, a high propellant efficiency of up to 82%, and a thrust level of up to 1.5 mN with 30 mA of beam current.

The MiXI thruster also has a cylindrical sidewall or anode wall with ring magnets of alternating polarity, and a backplate also at anode potential and through which the cathode assembly extends. The ring-cusp discharge for the MiXI thruster uses weakened samarium cobalt magnets to maintain a stable discharge via weakened cusp-field strength. Therefore, the MiXI thruster also operates at high discharge loss (˜450 eV/ion) and low electrical efficiency (˜40%) relative to larger ion sources. The MiXI thruster does exhibit a notably flat beam profile accomplished by aligning the cusp/plasma structure along the extraction plane.

Microwave and RF miniature discharge designs are also known in the art, and some embodiments to date have demonstrated certain operational advantages but generally yield lower performance in comparison to their DC/ring-cusp counterparts at all scales, miniature to large.

Larger scale ion sources, i.e., ion sources having a diameter of greater than 10 cm, for space propulsion have long exceeded the performance and operational life of terrestrial applications due to more stringent requirements for better efficiencies and lower erosion rates for space propulsion. However, many ion source applications require a smaller beam profile where larger source require high vacuum pumping and electric power, while conventional miniature sources perform poorly. Therefore, modern ion sources use either a duoplasmatron for single aperture beams and DC Kaufman or RF discharges for larger gridded beam source.

A new approach to an ion beam generator disclosed herein and referred to as an Axial Ring-Cusp Hybrid (ARCH) discharge device or ion beam generator has been shown to provide an efficient mN-class and mA-class thruster/ion-source, with applications to space thrusters as well as terrestrial ion beam applications. The ARCH discharge device has the unique ability to very efficiently confine all plasma elements (i.e., high-energy ‘primary’ electrons, plasma electrons, ions, and neutral gas). Most notably, the ARCH discharge can efficiently confine primary electrons at all scales, including miniature and small discharge scales that otherwise exhibit high-loss behavior with conventional DC (e.g., ring-cusp and Kaufmann) discharge designs. In particular, a key advantage of the ARCH design is the ability to effectively confine all of the plasma elements, and in particular the primary electrons such as those produced by the cathode assembly, in small and miniature scale devices.

In plasma processing, the ARCH ion beam generator can be used for a wide variety of micro and nano-scale fabrication where low background pressures, high ion energy, and highly anisotropic sputtering is desired. Ion beams are commonly used for ion beam etching (IBE), reactive IBE (RIBE), ion beam assisted deposition (MAD), ion beam sputter deposition (IBSD), and ion implantation. The high propellant utilization of the ARCH discharge means less excess gas leakage into chamber, while the flat beam profiles allows for smaller sized devices for the required tasks. This leads to reduced vacuum pumping requirements and/or lower overall background pressures. The higher efficiency will results in lower production of doubly charged ions, less erosion and contamination, and higher beam densities. These improvements are of great importance to the plasma-processing community since they would allow for greater manufacturing precision and speed, and/or improvement to the performance of the fabricated components.

Plasma discharges need to consider many aspects for performance, particularly at the miniature scale. It is often desirable to have high electrical or power efficiency, high propellant (or “mass utilization”) efficiency, a wide range of throttle-ability, high plasma and beam uniformity (“beam flatness”), and desirable thermal management to keep certain parts of the device hot or cold depending on their role in the operation of the discharge. All of these factors have various levels of importance depending on the application. Also, there are often tradeoffs between many of these factors. For example, one may choose to operate at lower performance or lower uniformity at some operating conditions or power levels to allow a greater range of throttle-ability. Sometimes discharge plasma that is higher efficiency is prone to instabilities, therefore, it is sometimes desirable to reduce the efficiency of a discharge to improve its stability. It also is important to note that high beam flatness can improve the life of the thruster by not allowing concentrated areas of high erosion of the grids.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

An ion beam generator including a discharge chamber having a tubular sidewall and backplate. A source of propellant, for example a reservoir containing a noble gas, provides propellant to the discharge chamber. A first annular magnet and a second annular magnet, each with one pole face adjacent to or narrowly spaced from the backplate and a second pole face opposite the first pole face, are configured with opposing polarity such that they generate a magnetic field in the discharge chamber defining at least two ring-cusps at the backplate. A cathode assembly extends into the discharge chamber and is configured to provide primary electrons to the discharge chamber. An extraction grid at an outflow end of the discharge chamber accelerates ions from the chamber. The ion beam generator does not include any magnets configured to form a magnetic ring-cusps along the sidewall.

In an embodiment, the sidewall is insulated from the backplate.

In an embodiment the first and second annular magnets each comprise either a continuous annular magnet or a discontinuous annular magnet comprising a plurality of spaced-apart magnets.

In an embodiment the first and second annular magnets are spaced from the backplate.

In an embodiment the first and second annular magnets comprise rare-earth magnets or electromagnets.

In an embodiment the first and second annular magnets are coaxial.

In an embodiment a third annular magnet is provide coaxial with the first and second annular magnets and disposed adjacent to or narrowly spaced from the backplate, and the first, second, and third annular magnets are configured with alternating polarity to generate a magnetic field extending into the discharge chamber that define at least three magnetic ring-cusps at the backplate.

In an embodiment the first and second annular magnets are fixed to a surface of the backplate.

In an embodiment the backplate is frustoconical.

In an embodiment at least one of the first and second annular magnets defines a pole face that is frustoconical and parallel with the frustoconical backplate.

In an embodiment at least one of the first and second annular magnets is canted.

In an embodiment an annular electrode is disposed in the discharge chamber and insulated from the backplate. The bias voltage of the annular electrode may be floating, or a controllable bias voltage may be applied to the annular electrode.

In an embodiment the backplate comprises a plurality of apertures providing flow paths for propellant into the discharge chamber.

In an embodiment a propellant plenum is disposed opposite the discharge chamber, and configured to provide propellant to the plurality of apertures.

In an embodiment an annular trim electromagnet is disposed around the tubular sidewall.

An ion thruster includes a discharge chamber having a backplate at the first end and a tubular sidewall. A source of propellant gas is connected to provide propellant to the discharge chamber. A first annular magnet and a second annular magnet have one pole face adjacent to or narrowly spaced from the backplate and a second pole face opposite the first pole face, and the first and second annular magnets are configured with opposing polarity such that they generate a magnetic field in the discharge chamber defining at least two ring-cusps at the backplate. A annular electrode is disposed in the discharge chamber and insulated from the backplate. A cathode assembly extending into the discharge chamber is configured to provide primary electrons to the discharge chamber. An extraction grid assembly is provided at an outflow end of the discharge chamber. In particular, the ion beam generator does not include any magnets configured to form a magnetic ring-cusps at the sidewall.

In an embodiment the first and second annular magnets comprise coaxial rare-earth magnets or electromagnets.

In an embodiment a third annular magnet is provided coaxial with the first and second annular magnets and disposed adjacent to or narrowly spaced from the backplate, wherein the first, second, and third annular magnets are configured to generate a magnetic field extending into the discharge chamber producing at least three magnetic ring-cusps at the backplate.

In an embodiment the backplate is frustoconical.

In an embodiment at least one of the first and second annular magnets defines a pole face that is frustoconical and parallel with the frustoconical backplate.

In an embodiment at least one of the first and second annular magnets is canted.

In an embodiment an annular trim electromagnet disposed around the tubular sidewall.

An ion beam generator includes a discharge chamber. A source of propellant is connected to provide propellant to the discharge chamber. A first annular magnet is configured with one pole face adjacent to or narrowly spaced from the backplate and an opposite pole face facing away from the backplate such that the first annular magnet generates a magnetic field in the discharge chamber defining a ring-cusp at the backplate. A cathode assembly extends into the discharge chamber and is configured to provide primary electrons to the discharge chamber. An extraction grid is disposed at the outflow end of the discharge chamber. The ion beam generator does not include any magnet configured to form a magnetic ring-cusp along the sidewall.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1A is a perspective view of an ion beam generator in accordance with the present invention with the accelerator grid not shown;

FIG. 1B is a sectional view of the ion beam generator shown in FIG. 1A;

FIG. 1C is a partially exploded perspective view of the ion beam generator shown in FIG. 1A;

FIG. 2 illustrates schematically a second configuration of an ion beam generator in accordance with the present invention;

FIG. 3 illustrates schematically a third configuration of an ion beam generator in accordance with the present invention, and having three annular magnet assemblies on the backplate;

FIG. 4 illustrates schematically a fourth configuration of an ion beam generator in accordance with the present invention and having at least one of the annular magnets are canted; and

FIG. 5 illustrates schematically a fifth configuration of an ion beam generator in accordance with the present invention and having a frustoconical backplate.

### DETAILED DESCRIPTION

According to an embodiment of the technology, a miniature direct-current ion beam generator is disclosed with a magnetic field design with improved discharge and mass utilization efficiency. The disclosed device is referred to as an Axial Ring-Cusp Hybrid (ARCH) discharge device. The ARCH technology provides an efficient mN-class and mA-class thruster/ion-source, with applications to space thrusters as well as terrestrial ion beam applications.

An important aspect of the ARCH technology is a magnetic field topology that reduces high energy (primary) electron loss to the chamber walls while maintaining a desirable beam profile. The design also prevents or reduces the loss of lower energy plasma electrons and ions to the walls, and loss of unionized “neutral” atoms and molecules through the grids. In some embodiments the ARCH ion beam generator includes tunable magnetic fields, a magnetic field structure with field lines generally aligned with a sidewall anode surface to independently collect plasma electrons to sustain a stable discharge current, and a chamber design that produces high ion beam output with reduced thermal loading of the discharge body, magnets, and other sensitive components. The design approach is highly scalable to lower and higher power and grid diameter.

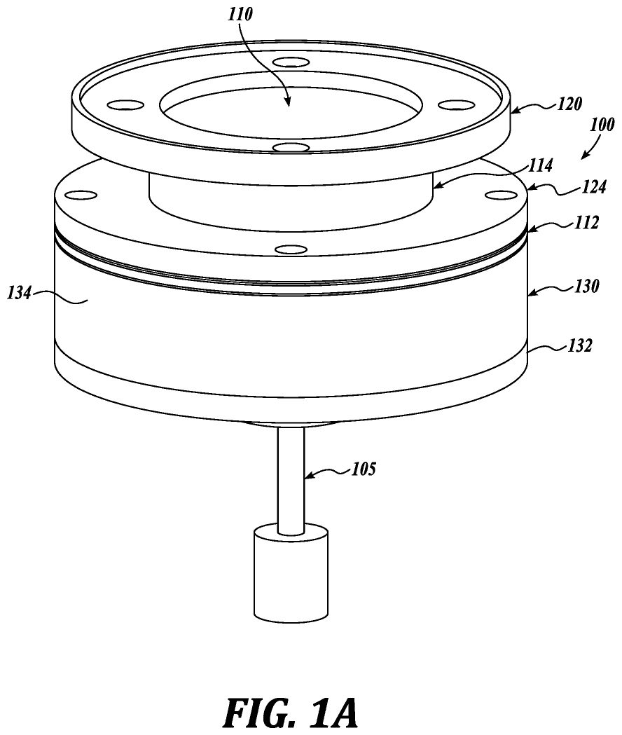

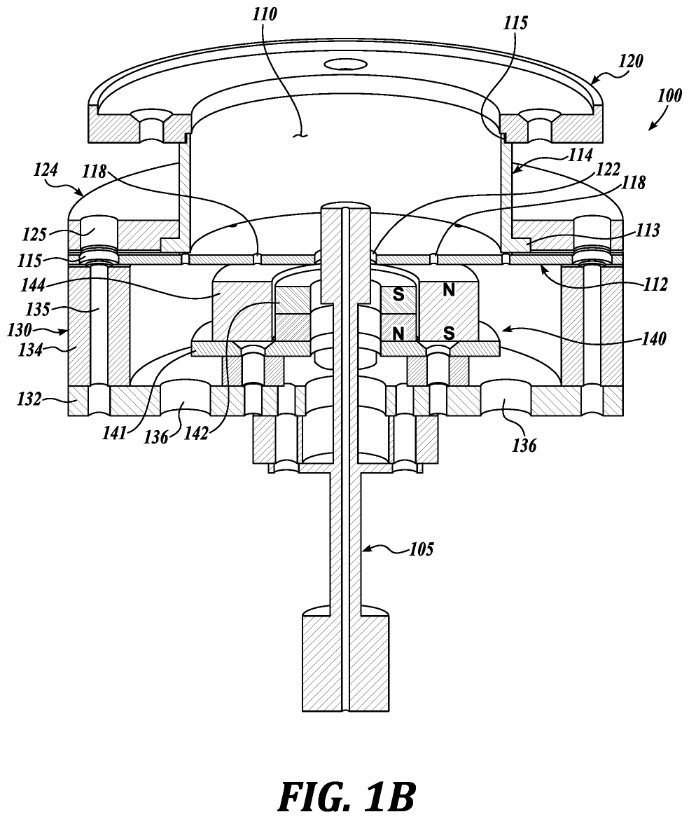

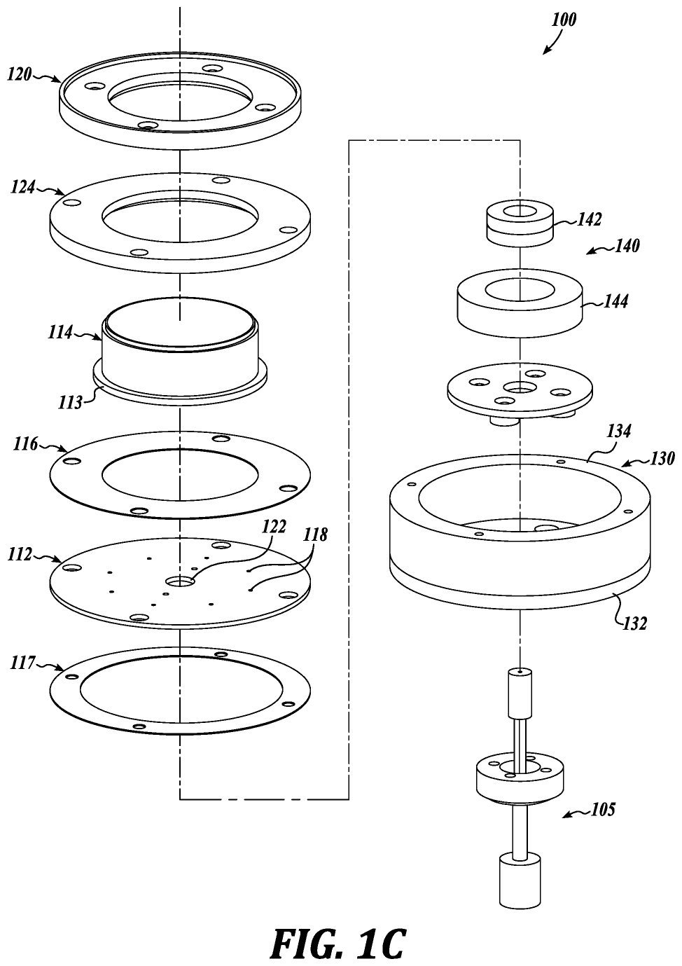

FIG. 1A illustrates in perspective view an ARCH ion beam generator 100 and plenum 130 in accordance with the present invention, wherein the conventional accelerator grid assembly and conventional connecting hardware are not shown, for clarity. Refer also to FIG. 1B, which shows a sectional view of the ion beam generator 100, and to FIG. 1C, which shows a partially exploded view of the ion beam generator 100. In this embodiment the ion beam generator 100 includes a conventional cathode assembly 105 as are known in the art. The cathode assembly 105 may be an electron source of any kind such as a simple filament, dispenser cathode, or a more advanced hollow cathode for longer lifetime. It is contemplated that other mechanisms for generating primary electrons known in the art may alternatively be used, including, for example, low work function materials and field emission cathodes.

In this embodiment the ion beam generator 100 includes a discharge chamber 110 and a propellant plenum 130 adjacent to the discharge chamber 110. The cathode assembly 105 is centrally mounted, and extends through the propellant plenum 130 and into the discharge chamber 110. A mounting ring 120 for attaching the grid assembly (not shown) is provided at an outflow end of the discharge chamber 110.

The propellant plenum 130 includes a plenum backplate 132 and a plenum sidewall 134. Apertures or inlet ports 136 in the backplate 132 are configured to connect with a source of propellant, for example, a reservoir of xenon gas or other propellant system (not shown) for actively or passively providing propellant to the plenum 130. For example, propellant may be provided at a prescribed flow rate. In this embodiment the propellant plenum 130 houses a magnet system 140 including two or more spaced concentric annular magnets 142, 144. The annular magnets 142, 144 may be any suitable type of magnet, as are well known in the art, including permanent magnets or electromagnets. For example, in a current embodiment the annular magnets 142, 144 are rare-earth samarium-cobalt permanent magnets.

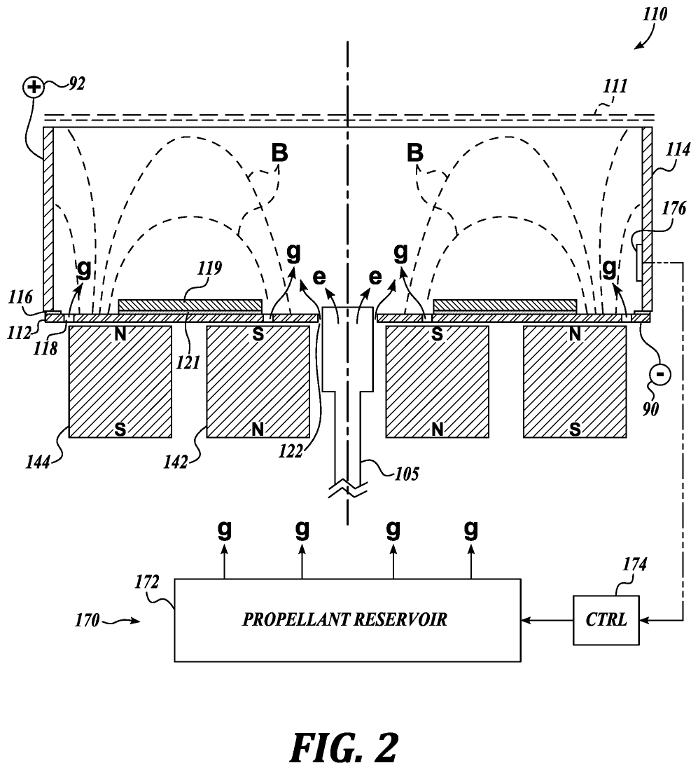

The annular magnets 142, 144 are magnetized in the axial direction with a north pole face oppositely disposed from a corresponding south pole face. The annular magnets 142, 144 are configured to have opposing or alternating polarities (as indicated with “N” and “S” in FIG. 1B). For example, in FIG. 1B the inner annular magnet 142 is oriented with the south pole face oriented towards the backplate 112, and the outer annular magnet 144 is oriented with the north pole face oriented towards the backplate. A magnetic pole piece 141 engages pole faces of the magnets 142, 144 opposite the discharge chamber 110. It will be appreciated by persons of skill in the art that although the annular magnets 142, 144 are shown as a continuous annular magnet, they may alternatively comprise a plurality of spaced apart or adjacent magnets arranged in an annular configuration. “Annular magnets” are herein expressly defined to refer to either unitary annular magnets or segmented magnets arranged in an annular configuration. It will also be appreciated from the diagram shown in FIG. 2 that the alternating polarity magnets 142, 144 produce regions with magnetic ring-cusps at the backplate 112.

Although in this embodiment the magnet system 140 is disposed outside of the discharge chamber 110, in other embodiments (not shown) the annular magnets may alternatively be positioned on or above an upper surface of a discharge chamber 110 backplate 112, e.g., inside the discharge chamber 110, and in other embodiments the magnet system 140 may be recessed or encased in a backplate 112 of the discharge chamber 110.

The discharge chamber 110 includes the discharge backplate 112 that in this embodiment also defines an end plate of the propellant plenum 130, and a tubular sidewall 114 that extends from the backplate 112. The backplate 112 includes one or more ports 118 between the propellant plenum 130 and the discharge chamber 110, permitting a flow of propellant into the discharge chamber 110. A center aperture 122 in the backplate 112 is sized to receive an end of the cathode assembly 105 therethrough and has a transverse dimension larger than the end of the cathode assembly 105 such that an insulating gap is defined between the cathode assembly 105 and the backplate 112. The insulating gap 122 may be open to permit propellant to enter the discharge chamber 110 from the plenum 130, or may be partially or fully blocked.

Although the backplate 112 in this embodiment is a flat plate, it is contemplated that the backplate may be shaped, for example, the backplate may be frustoconical or have a frustoconical or domed portion.

The inflow end of the sidewall 114 includes a flange 113 that engages the backplate 112. An annular bracket 124 is positioned to engage the flange 113, and configured to clamp the sidewall 114 to the corresponding backplate 112. In the disclosed embodiment the plenum sidewall 134, a radially outer portion of the backplate 112, and the annular bracket 124 include apertures 135, 115, 125 that are aligned and configured to receive attachment hardware therethrough (not shown) to attach the discharge chamber 110 to the propellant plenum 130. In other embodiments propellant may be provided directly to the discharge chamber 110 without a plenum, or may be provided through a plenum spaced apart from the discharge chamber.

In this embodiment, and as seen most clearly in FIG. 1C, a first annular insulator panel 116 is disposed between the discharge chamber backplate 112 and sidewall 114, and configured to electrically and thermally insulate the backplate 112 from the sidewall 114 and the bracket 124, and a second insulator panel 117 insulates the backplate 112 from the plenum sidewall 134. In other embodiments the sidewall and backplate are unitarily formed as a single piece.

A novel aspect of the ion beam generator 100 is that the two or more axially polarized (i.e., polarized in the vertical direction in FIG. 1B) annular magnets are disposed only on or near the backplate 112 of the discharge chamber 110, and in particular there are no alternating magnets on or associated with the sidewall 114 of the discharge chamber 110. Therefore, no magnetic ring-cusp regions are formed on the sidewall 144

In an exemplary embodiment the ion beam generator 100 has a discharge chamber 110 with a diameter of less than 5 cm, for example, 3 cm, and is designed to operate between about 20 W to about 100 W of total power. In an exemplary embodiment the magnetic field topology is produced with concentric samarium cobalt ring magnets 142, 144, though other magnet materials or electromagnets may alternatively be used for all or some of the magnetic field sources. The magnets 142, 144 are axially magnetized (i.e., parallel to the center axis of the discharge chamber 110) and placed in alternating polarity producing two ring-cusps that terminate onto the backplate 112. The magnets 142, 144 engage the magnetic pole piece 141 and are radially spaced, with a gap between the first magnet 142 and the second magnet 144. In this embodiment the magnets 142, 144 are also spaced away from the backplate 112, to minimize thermal loads on the magnets 142, 144. The anode sidewall 114 is electrically and thermally insulated from the backplate 112 and maintained at an anode potential. The insulator panels 116, 177 in this embodiment are ceramic washers.

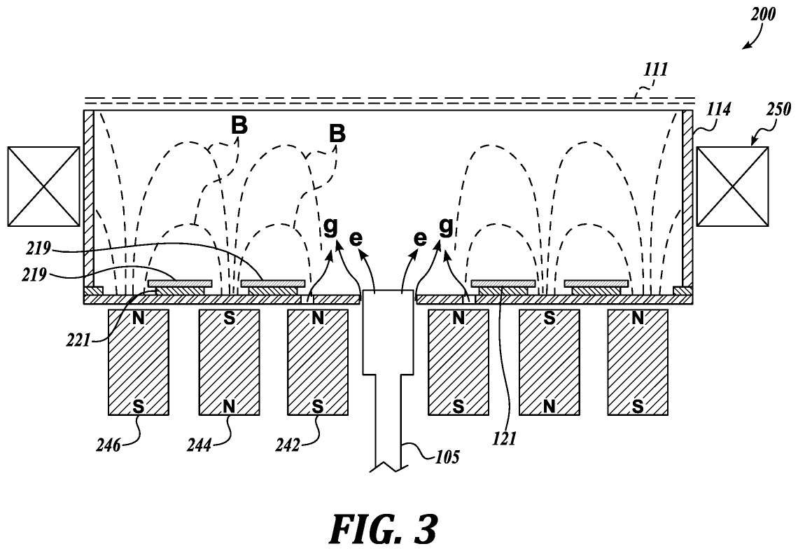

Neutral propellant gas (for example, xenon) enters the discharge chamber 110 through the cathode opening 122 and/or ports 118, and/or the cathode assembly and orifice 105. Other means for introducing the propellant gas are known in the art, and may alternatively be used. In one embodiment, the cathode assembly 105 includes a thermionic filament and is installed with the primary electron flow substantially coplanar with the backplate 112. The filament cathode 105 may be a hollow cathode (as shown) to increase lifetime and reduce discharge heating. In some embodiments a magnetic field is provided one or more trim coil electromagnets 250 wrapped directly around the sidewall 114 (see, for example, FIG. 3, however, this could be used in any embodiment of the invention). Such trim coil electromagnets 250 will operate more efficiently due to the proximity of the coil to the sidewall 114. (The trim coil 250 does not produce a ring-cusp, but rather, produces a magnetic field within the discharge that is substantially aligned with the discharge axis.) Alternatively to the trim coil, tunable or movable permanent magnets may be provided on the sidewall 114. The trim coil magnet(s) 250 provide a means for tuning the discharge field within the chamber 110 by actively modifying the magnetic field produced by the magnets 142, 144 in the chamber 110.

The magnetic field may be produced by electromagnets or permanent magnets. Tunable electromagnets and/or or moveable or thermal modifiable permanent magnets may be used to change the magnetic field inside the discharge chamber to allow modification to the performance or behavior of the discharge. For example, the magnets may be tuned to operate in a higher efficiency mode with regards to power or propellant efficiency. Also, the magnets may be used to tune the discharge magnetic field to create a “lossy” plasma discharge that improves plasma stability and allows for greater throttleability. Such tuning may also be used to provide greater beam flatness, which can improve life and may or may not improve efficiency, depending on the desired performance criteria for the device and application.

In some embodiments an extraction grid system 111 (see FIG. 2) is designed based on Small Hole Accelerator Grid (SHAG) optics, but any grid geometry can be used as are well known in the art, including for example, the Small Hole Thick Accelerator Grid (SHTAG) optics. These grids may be biased to extract ions, electrons, or both, using alternating polarity.

In a current embodiment, the height of the chamber is designed such that the magnetic fields are approximately 10 G to 30 G along the extraction plane. However, different aspect ratio can be used depending on beam and ion content desired. The inner and outer ring-cusps are typically sized so that the apogee of the cusp is between the radial location of the anode and cathode. Different B-fields can be achieved via trim coils or electromagnetic options. The outer cusp is preferably placed sufficiently outwards for a wider profile to avoid the ring-cusp structure from bowing outwards to make substantial contact with the anode sidewall 114.

Refer now also to FIG. 2, which is a diagrammatic illustration of the discharge chamber 110 of the ion beam generator 100 with the accelerator grid assembly 111, and an optional annular electrode 119 disposed in the discharge chamber 110 and insulated from the backplate 112 with insulators 121. The annular electrode 119 may have a voltage that is allowed to float, or the electrode 119 may be controllably biased to a desired voltage.

The discharge chamber sidewall 114 is maintained at an anode potential 92, and is insulated from the backplate 112, which is maintained at or below the cathode potential 90. The magnetic field lines B from the alternating polarity annular magnets 142, 144 extend into the discharge chamber 110, forming spaced-apart ring-cusps with magnetic field lines approximately perpendicular to the backplate 112. In particular, there is no ring-cusp region on the sidewall 114. Primary electrons (indicated as “e” in FIG. 2) emitted from the cathode assembly 105 are retained longer within the discharge chamber 110 radially inward from the outer ring-cusp by the magnetic field B. The cathode potential 90 of the backplate 112 prevents or greatly reduces the loss of primary electrons to the backplate 112. The primary electrons e, therefore, are more available to ionize the propellant gas.

A portion of the propellant gas g entering the discharge chamber 110 becomes ionized by the primary electrons e, and the diffusive plasma electrons are substantially collected at the anode potential sidewall 114. Therefore, heating of the discharge chamber 110 is substantially concentrated in the sidewall 114, which is thermally isolated from the backplate 112 and the magnets 142, 144 by insulator 116.

The weaker axial magnetic fields allow discharge current to be maintained at relatively low discharge voltages. Increasing plasma density increases diffusivity which allows for higher discharge currents.

An electrode 119 can be used to increase discharge efficiency. For example, the electrode 119 can be allowed to float relative to the plasma, which will increase its potential in order to confine ions. The electrodes 119 may be actively biased to further improve ion confinement, or alternatively be used to partially shield the primary electrons e from the cathode potential of the backplate 112, improving the efficiency of the primary electrons and preventing or reducing the heat load on the backplate 112. The electrodes 119 may be sized (for example, heuristically) to minimize the number of primary electrons e impacting the backplate 112.

Prior art ion beam generators generate ring-cusps on the cylindrical sidewall, generating strong radial gradients that are generally undesirable. Positioning the magnets 142, 144 only on or at the backplate 112 generates a magnetic field that decreases in strength axially through the discharge chamber 110 towards the accelerator grid assembly 111, which has the advantage of producing improved ion beam flatness. The magnetic field lines diverge from the centerline and along the extraction plane for even and efficient plasma generation.

Placement of the alternating polarity annular magnets 142, 144 on the backplate 112 produces a magnetic field B with magnetic cusps on the back surface of the discharge chamber 110, and regions in the discharge chamber with field lines that are substantially vertical in a large portion of the discharge chamber 110. The magnetic field B is therefore fundamentally different from conventional ion beam sources (see, for example, Sovey et al.) wherein the magnetic field lines are substantially horizontal forming ring-cusps on the sidewall. Also the backplate 112 in this embodiment is at a cathode potential, and the anode potential is at the sidewall 114, disposed relatively far from the cathode assembly 105. The discharge chamber 110 geometry and the magnetic field B combine to reduce the loss of primary electrons generated by the cathode assembly 105 from being lost to the anode sidewall 114. Although in currently preferred embodiments the backplate 112 is at a cathode potential and insulated from the sidewall 114, in other embodiments the sidewall is directly connected with the backplate, and they are both at an anode potential. In such an embodiment, the electron confinement at the cusp can be augmented by an optional annular electrode (not shown) located at one or more cusps that can be biased to a lower potential.

A propellant source 170 comprising a reservoir of propellant 172 provides propellant to the discharge chamber 110. The flow rate of propellant may be adjusted, for example, to achieve desired ion beam properties. For example, the flow rate of the propellant may be adjusted with a controller 174, such as an electronic processor, which may receive sensor data from one or more sensors 176 along the propellant line (not shown), in the discharge chamber 110, in the grid system 111, in the outflow ion beam, or the like, and use the received data to control the flow of propellant to the discharge chamber 110.

It will be appreciated by persons of skill in the art, based on the teachings herein, that in very small diameter ion beam generators 100 it may be preferable to include only one of the first and second annular magnets 142, 144 at or below the backplate 112 to generate a single magnetic ring-cusp at the backplate 112.

FIG. 3 illustrates another embodiment of an ion beam generator 200 in accordance with the present invention. Except as otherwise described, the ion beam generator 200 is similar to the ion beam generator 100 shown in FIG. 2. For clarity, similar features of the different embodiments will not be repeated.

In this embodiment, three annular magnets 242, 244, 246 are disposed with alternating polarity on, in, or below the backplate 112 of the discharge chamber 110. Such an embodiment may also employ more than three annular magnet arrangements. As with the previously described ion beam generator 100, the sidewall 114 is insulated from the backplate 112, and provides a cylindrical anode surface. One or more segmented annular floating electrodes 219 are optionally disposed on the backplate 112 with corresponding insulators 221 between the electrodes 219 and the backplate 112. Magnetic ring-cusps are produced at the backplate 112, for example, between and outboard of the electrodes 219, as indicated by the magnetic field lines B. Although in this embodiment the ring-cusps are produced at the backplate 112 between the electrodes 219, in other embodiments, more than two electrodes may be provided, and the electrodes may be configured to generally overlie the magnets 242, 244, 246, such that the ring cusps are formed at the electrode.

Primary electrons e from the cathode assembly 105 are emitted at the center of the inner annular ring-cusp, which reduces loss of the primary electrons e to the anode sidewall 114, allowing the primary electrons to more effectively ionize the propellant gas g. Optionally, a controllable electromagnetic coil 250 located around the sidewall 114, or located behind the backplate 112, is configured to act as trim coils, and may be operated to fine-tune plasma electron confinement.

It is contemplated that in other embodiments more than three annular magnets may be disposed with alternating polarity on, in, or below the backplate 112 of the discharge chamber 110.

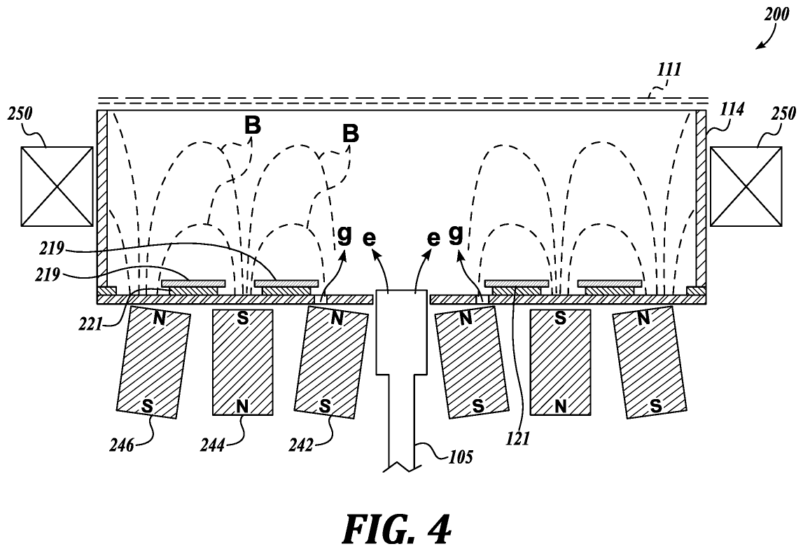

FIG. 4 illustrates another embodiment of an ion beam generator 300 in accordance with the present invention. Similar to the embodiment of FIG. 3, three annular magnets 242, 244, 246 are disposed with alternating polarity at the backplate 112 of the discharge chamber 110. In this embodiment the inner and outer annular magnets 242, 246 are canted, or at an angle with respect to the discharge axis. Canting one or more of the annular magnets 242, 244, 246 with alternating polarity allows the designer to modify the orientation of the magnetic field lines in the discharge chamber 110, for example, to reduce the loss of primary electrons to the sidewall 114, increasing the mean time that the primary electrons e are retained in the discharge chamber 110 to ionize the gas propellant. Such canting can also improve confinement of the plasma electron and/or ions.

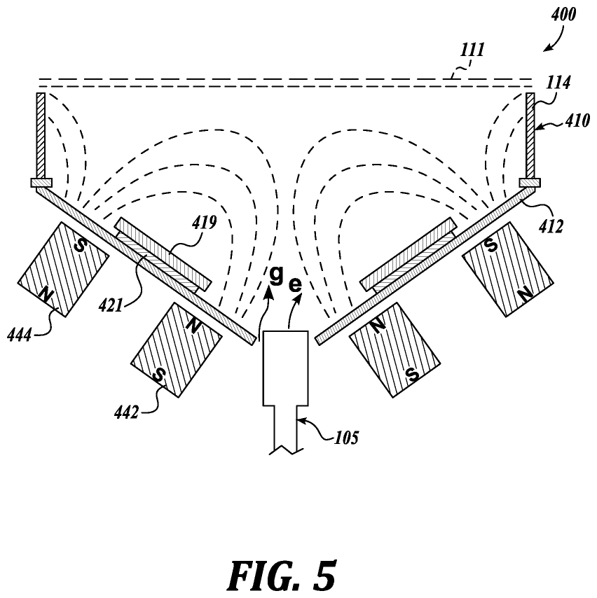

FIG. 5 illustrates another embodiment of an ion beam generator 400 that is similar to the ion beam generator shown in FIG. 2, and having a frustoconical backplate 412, with annular magnets 442, 444 associated with the backplate 412, and that are polarized conically, as indicated. As in the previous embodiments, the annular magnets 442, 444 may be formed as unitary annular magnets, or a plurality of magnets arranged in an annular configuration. A frustoconical annular floating or controllably biased electrode 419 may be positioned on the backplate 412, with an insulating member 421 positioned between the electrode 419 and the backplate 412.

The frustoconical backplate 412 (at a cathode potential) allows the sidewall 414 (at an anode potential) to be relatively smaller, for the same enclosed volume. The smaller anode area results in potentially fewer primary electrons e loss to the sidewall 414, and increases the effectiveness of the primary electrons e in ionizing the propellant gas g. Such a configuration would be attractive for increased overall thruster diameters, and therefore could employ more than two annular arrangements of magnets along the backplate 412.

Although in FIG. 5 the annular magnets 442, 444 are canted such that the magnetic fields produced by the annular magnets 442, 444 are oriented generally perpendicular to the frustoconical backplate 412 in the vicinity of the backplate 412, it is contemplated that one or both of the annular magnets 442, 444 may alternatively be canted differently, for example, such that the polarity of one or both of the annular magnets 442, 444 are oriented vertically. This construction provides the designer with significant flexibility in designing the B-field inside the discharge chamber.

The disclosed ion beam generator design is easily amenable to miniaturization to sub-centimeter designs, and up to 10 cm configurations. For larger configurations, a repeating array of backplate magnets would accommodate ion beam generators having a diameter greater than 10 cm.

A current embodiment of a 3 cm ARCH discharge device achieves a total efficiency of 74%, a propellant efficiency of 92%, and a beam current of 60 mA for the same grid diameter and discharge power as the well-known MIXI thruster that uses a conventional ring-cusp geometry. Due to improved primary confinement, this translates to a discharge loss of 245 eV/ion and electrical efficiency of 82%, a considerable improvement compared to conventional ring-cusp design.

Compared to available specifications for the Kaufman ion sources such as the KRI KDC40, the ARCH discharge can produce similar beam currents at ˜10 mA/cm2 but at discharge voltage of 25 V instead of the reported 100 V.

Traditional ring-cusp design principles have inherent design limitations at the miniature scale because their field structure dominates the bulk discharge. A radially magnetized ring magnet around the chamber walls generates strong magnetic field and density gradients along the radial direction, which generally leads to poor beam flatness and poor overall performance. Therefore, the overall magnetic fields must be limited to configurations that would precisely align the cusp structure along the extraction plane. In addition, high-energy “primary” electrons and “lower-energy” “plasma” electrons are lost relatively prodigiously to the cusp leak area. The total cusp leak area must be adequate to extract a stable discharge current which leads to excessive loss of primary electrons.

The ARCH discharge differs from conventional thruster designs due to its highly unique field topology and its unprecedented performance for its scale. The ARCH discharge addresses the key obstacles with traditional ring-cusp design: primary electron confinement and beam uniformity. As shown in the attached figure, the magnetic cusps are axially aligned and in a concentric pattern along the rear plate. The rear plate can be adjusted over a wide range of potentials to maximize performance (typically near cathode potential), while the anode voltage, relative to the electron emitting cathode, is applied to the cylindrical walls. This geometry maintains a strong cusp but with the field gradient along the axial direction towards the extraction plane. Therefore, the design exhibits a topology with uniformly low magnetic fields along the entire grid plane, resulting in good beam flatness. In addition, due to the magnetic field geometry and the rear plate bias, there is no directly exposed cusp to anode potential. This significantly increases the confinement of the high-value primary electrons (which provide the energy to generate the discharge) while the plasma electrons that result from ionization collisions are sufficiently lossy to prevent discharge impedance shift instabilities. Lastly, since most or all of the discharge current can be collected at the cylindrical walls, which can be insulated from the rear plate. This allows the ARCH discharge to operate at higher discharge currents and plasma densities without the risk of overheating the magnets.

The ARCH discharge design is an ideal candidate as an ion source for miniature ion thruster for space propulsion applications. Similarly, it is well-suited for ion beam etching with plasma processing, particularly in nano-fabrication. Both of these applications still employ traditional ring-cusp and Kaufman-type discharge chambers for DC plasma generation.

Regarding space missions, highly efficient miniature ion thrusters that are enabled by the ARCH discharge are a key enabling technology for future missions for microsatellites and larger satellites. Recently, miniature spacecraft technologies and approaches have increased the capabilities and science return that can be delivered by microsatellites, thus greatly increasing the need for efficient miniature ion thrusters. The ARCH discharge enables efficient miniature ion thrusters that offer an important and unique capability for mission and spacecraft designers since they are capable of delivering desirable thrust levels (in the mN range), thrust control, propellant efficiency (Isp ˜1500 to 4000 s), and high mission delta-V (which is a measure of the effective total mission capability provided by a thruster). By reducing the power consumption and inert mass of the propulsion system, this invention can enable missions for microsatellites (10-100 kg) or smaller craft for missions that were once unachievable for such small vehicles. Larger spacecraft (>100 kg) are increasingly implementing electric propulsion and would benefit greatly from the ability to use these highly efficient miniature thruster for both primary and secondary propulsion, which can be applied to all mission classes. These mission classes include: Earth-orbiting, exploration, space and terrestrial planet observatories, space tugs, and formation flying.

While illustrative embodiments have been illustrated and described, it will be appreciated that various changes can be made therein without departing from the spirit and scope of the invention.

The embodiments of the invention in which an exclusive property or privilege is claimed are defined as follows:

1. An ion beam generator comprising:
a discharge chamber having a first end and an outflow end, the discharge chamber comprising a backplate at the first end and a tubular sidewall;
a source of propellant connected to provide propellant to the discharge chamber;
a first annular magnet and a second annular magnet, wherein the first and second annular magnets each have a first pole face adjacent to or narrowly spaced from the backplate and an opposite pole face oriented away from the backplate, and wherein the first and second annular magnets are configured with opposing polarity such that they generate a magnetic field in the discharge chamber defining at least two ring-cusps at the backplate;
a cathode assembly extending into the discharge chamber and configured to provide primary electrons to the discharge chamber; and
an extraction grid disposed at the outflow end of the discharge chamber;
wherein the ion beam generator does not include any magnet configured to form a magnetic ring-cusp at the sidewall.

2. The ion beam generator of claim 1, wherein the sidewall is insulated from the backplate.

3. The ion beam generator of claim 1, wherein the first and second annular magnets each comprise either a continuous annular magnet or a discontinuous annular magnet comprising a plurality of spaced-apart magnets.

4. The ion beam generator of claim 1, wherein the first and second annular magnets are spaced from the backplate.

5. The ion beam generator of claim 1, wherein the first and second annular magnets comprise rare-earth magnets or electromagnets.

6. The ion beam generator of claim 1, wherein the first and second annular magnets are coaxial.

7. The ion beam generator of claim 6, further comprising a third annular magnet coaxial with the first and second annular magnets and disposed adjacent to or narrowly spaced from the backplate, wherein the first, second, and third annular magnets are configured to generate a magnetic field extending into the discharge chamber and defining at least three magnetic ring-cusps at the backplate.

8. The ion beam generator of claim 1, wherein the first and second annular magnets are fixed to a surface of the backplate.

9. The ion beam generator of claim 1, wherein the backplate is frustoconical.

10. The ion beam generator of claim 9, wherein the first pole face of at least one of the first and second annular magnets is frustoconical and parallel with the frustoconical backplate.

11. The ion beam generator of claim 1, wherein at least one of the first and second annular magnets is canted.

12. The ion beam generator of claim 1, further comprising an annular electrode disposed in the discharge chamber and insulated from the backplate.

13. The ion beam generator of claim 12, wherein the annular electrode is configured to be biased to a controllable bias voltage.

14. The ion beam generator of claim 1, wherein the backplate comprises a plurality of apertures providing flow paths for propellant into the discharge chamber.

15. The ion beam generator of claim 14, further comprising a propellant plenum disposed opposite the discharge chamber, and configured to provide propellant to the plurality of apertures.

16. The ion beam generator of claim 1, further comprising an annular trim electromagnet disposed around the tubular sidewall.

17. An ion thruster comprising:
a discharge chamber having a first end and an outflow end, the discharge chamber comprising a backplate at the first end and a tubular sidewall;
a source of propellant connected to provide propellant to the discharge chamber;
a first annular magnet and a second annular magnet, wherein the first and second annular magnets each have a first pole face adjacent to or narrowly spaced from the backplate and an opposite pole face oriented directly away from the backplate, and wherein the first and second annular magnets are configured with opposing polarity such that they generate a magnetic field in the discharge chamber defining at least two ring-cusps at the backplate;
an annular electrode disposed in the discharge chamber and insulated from the backplate;
a cathode assembly extending into the discharge chamber and configured to provide primary electrons to the discharge chamber; and
an extraction grid assembly disposed at the outflow end of the discharge chamber;
wherein the ion beam generator does not include any magnet configured to form a magnetic ring-cusp at the sidewall.

18. The ion thruster of claim 17, wherein the first and second annular magnets comprise coaxial rare-earth magnets.

19. The ion thruster of claim 18, further comprising a third annular magnet coaxial with the first and second annular magnets and disposed adjacent to or narrowly spaced from the backplate, wherein the first, second, and third annular magnets are configured to generate a magnetic field extending into the discharge chamber and defining at least three magnetic ring-cusps at the backplate.

20. The ion thruster of claim 17, wherein the backplate is frustoconical.

21. The ion thruster of claim 17, wherein the first pole face of at least one of the first and second annular magnets is frustoconical and parallel with the frustoconical backplate.

22. The ion thruster of claim 17, wherein at least one of the first and second annular magnets is canted.

23. The ion thruster of claim 17, further comprising an annular trim electromagnet disposed around the tubular sidewall.

24. An ion beam generator comprising:
a discharge chamber having a first end and an outflow end, the discharge chamber comprising a backplate at the first end and a tubular sidewall;
a source of propellant connected to provide propellant to the discharge chamber;
a first annular magnet configured with one pole face adjacent to or narrowly spaced from the backplate and an opposite pole face facing away from the backplate such that the first annular magnet generates a magnetic field in the discharge chamber defining a ring-cusp at the backplate;
a cathode assembly extending into the discharge chamber and configured to provide primary electrons to the discharge chamber; and
an extraction grid disposed at the outflow end of the discharge chamber;
wherein the ion beam generator does not include any magnet configured to form a magnetic ring-cusp along the sidewall.

25. The ion beam generator of claim 24, wherein the sidewall is insulated from the backplate.

26. The ion beam generator of claim 24, wherein the first annular magnet comprises either a continuous annular magnet or a discontinuous annular magnet comprising a plurality of spaced-apart magnets.

27. The ion beam generator of claim 24, wherein the first annular magnet is spaced from the backplate.

28. The ion beam generator of claim 24, wherein the first annular magnet comprises a rare-earth magnet.
